(19) United States
(12) Patent Application Publication
(10) Pub. No.: US 2014/0221518 A1
(43) Pub. Date: Aug. 7, 2014

(54) COMPOSITION FOR USE IN THE MANUFACTURE OF POLYURETHANE SYSTEMS

(71) Applicant: EVONIK INDUSTRIES AG, ESSEN (DE)

(72) Inventors: Eva Emmrich-Smolczyk, Essen (DE); Harald Modro, Gladbeck (DE); Patrick Kuhlmann, Essen (DE)

(73) Assignee: EVONIK INDUSTRIES AG, Essen (DE)

(21) Appl. No.: 14/172,436

(22) Filed: Feb. 4, 2014

(30) Foreign Application Priority Data
Feb. 5, 2013 (DE) DE102013201825.8

(51) Int. Cl. C08G 18/08; C08G 18/06

(52) U.S. Cl. CPC C08G 18/14; C08G 18/06
USPC 521/174; 536/1.11; 528/48; 252/182.18; 252/183.11

(57) ABSTRACT

The invention relates to a composition for producing a polyurethane system, especially a polyurethane foam. The composition comprising one or more compounds comprising at least one 5- or 6-membered ring comprising one or two oxygen atoms and carbon atoms The present invention also relates to a process for producing polyurethane systems by using this composition as well as polyurethane systems obtained from such a process. The present invention also relates to the use of the polyurethane system of the present invention.

### FIELD OF THE INVENTION

The present invention relates to a composition for producing a polyurethane system, especially a polyurethane foam. Notably, the composition includes one or more compounds comprising at least one 5- or 6-membered ring comprising one or two oxygen atoms and carbon atoms. The present invention also relates to a process for producing polyurethane systems by using this composition as well as polyurethane systems obtained from such a process. The present invention also relates to the use of the polyurethane system of the present invention.

### BACKGROUND OF THE INVENTION

Polyurethane (PU) systems include, for example, polyurethane coatings, polyurethane adhesives, polyurethane sealants, polyurethane elastomers or polyurethane foams.

Polyurethane foams have outstanding mechanical and physical properties and thus are used in a very wide variety of applications. The automotive and furniture industries are a particularly important market for various PU foams, such as conventional flexible foams based on ether and ester polyols, cold-cure foams (frequently also referred to as HR foams), rigid foams, integral foams and microcellular foams and also foams with properties between these classifications, for example semi-rigid systems. For instance, rigid foams are used as an inner roof liner, ester foams as an interior door trim and also for die-cut sun visors, and cold-cure and flexible foams are used for seat systems and mattresses.

Catalysts suitable for one-component moisture-reactive polyurethane compositions usually comprise tin compounds, such as tin carboxylates, especially tin octoate (which corresponds to tin 2-ethylhexanoate), which are frequently combined with tertiary amines.

The use of tin octoate in the manufacture of flexible PU foams based on polyetherols is described, for example, in Steve Lee, Huntsman Polyurethanes, The Polyurethanes Book, Verlag Wiley, pp. 140, 143-144. Tin octoate catalyzes the reaction of isocyanates with polyols (it is also known as a gelling catalyst) via a complex transitory state. During foaming, the tin octoate hydrolyzes and releases not only the salt of 2-ethylhexanoic acid but also the acid itself. This decomposition is desired because it prevents the retroreaction of the urethane bond into the starting materials, but it should ideally not lead to the release of substances where there are toxicological concerns. The use of tin octoate is also described in many patent applications including, for example, GB 1432281, GB 1422056, GB 1382538, GB 1012653 or GB 982280. The preferred catalyst systems used in these references comprise tin octoate.

Dibutyltin dilaurate (DBTDL) is one of the most efficient catalysts in the manufacture of polyurethane foams, particularly high-resilience (HR) polyurethane foams, especially by the slabstock method, where the density distribution across a large slab of foam is to be as homogeneous as possible. There are health and ecotoxicological reasons why the use of DBTDL in the manufacture of polyurethane foams is more and more frequently avoided.

To help the automotive and furniture industries, and their foam suppliers, meet the increasingly tougher emission and toxicity requirements of recent years, catalyst systems have been developed on the basis of less toxic ligands which become part of the foam structure by polymerization. Systems of this type, which are typically based on ricinoleic acid are described, for example, in EP 1013704.

The systems referred to above were hitherto one of the few alternatives to the widely used tin octoate catalyst system (tin(II) salt of 2-ethylhexanoic acid) or organotin compounds, such as dibutyltin dilaurate. Notably the latter systems in particular give rise to concern with regard to the toxicity of the substances emitted. 2-Ethylhexanoic acid, emitted during and after foaming for example, represents a possible (teratogenic) risk of harm to an unborn child (R 63).

Yet the tin carboxylates frequently used as alternative catalysts may lead to large density variations in the resultant slabstock foam, which also have an effect on the dimensional stability thereof.

Slabstock foam is typically processed into mattresses by cutting it into uniform slices. In such applications, it is particularly important that foam density be uniform throughout the entire slabstock foam. There is a further link between the indentation resistance of a foam and its density. These two parameters are pivotally determinative of mattress quality. If in addition to having an unfavourable density distribution and indentation resistance, a slabstock foam also suffers from the so-called cold-flow effect (“trapezing”), large amounts of scrap will be generated when poorly deformed slabstock polyurethane foam blocks are cut up into the required slices.

### SUMMARY OF THE INVENTION

The present invention provides an additive for forming polyurethane systems, especially polyurethane foams, which overcomes the aforementioned disadvantages. Preferably, the composition of the present invention contains no DBTDL and in the manufacture of HR polyurethane foam provides slabstock foams having good cold-flow properties and a very homogeneous density distribution.

Notably, the present application provides composition for forming polyurethane systems which includes compounds comprising at least one 5- or 6-membered ring constructed of one or two oxygen atoms and carbon atoms.

The present invention also provides for the use of the compositions according to the present invention in a process for producing polyurethane systems, preferably polyurethane coatings, polyurethane adhesives, polyurethane sealants, polyurethane elastomers or polyurethane foams. The polyurethane systems according to the present invention can be used as refrigerator insulation, insulation panel, sandwich element, pipe insulation, spray foam, can foam, in particular 1 and 1.5 component can foam, wood imitation, modelling foam, packaging foam, mattress, furniture cushioning, automotive seat cushioning, headrest, dashboard, automotive interior trim, automotive roof liner, sound absorption material, steering wheel, shoe sole, carpet backing foam, filter foam, sealing foam, sealant and adhesive or for producing corresponding products.

The compositions, i.e., formulations, of the present invention have the advantage that they can be used for producing not only flexible foams based on ether and ester polyols, but also rigid foams and also foams with properties between these two classifications, for example semi-rigid foams.

The compositions of the present invention additionally have the advantage that they can be used to obtain polyurethane systems which are completely free from organotin compounds, i.e., compounds having an Sn—C bond, specifically free from DBTDL.

Slabstock polyurethane foams obtained with the compositions of the present invention have a relatively uniform (foam) density throughout. Rigidity differences within the polyurethane slabstock foam obtained are only minimal as a result of the relatively uniform density of the foam.

Use of the compositions according to the present invention in the manufacture of slabstock polyurethane foams provides slabstock foams having only minimal deformations. As a result, the slabstock foams can be further processed without generating a lot of scrap.

One definition of cold flow is the distortion, deformation or dimensional change which takes place in materials under continuous load at ambient temperature (source: CRC Press LLC, 1989). By “continuous load” it is meant the slabstock foam's own weight. A deformed appearance on the part of the slabstock foam is linked to an inhomogeneous distribution of the density throughout the entire foam and hence also some variance in the impression resistance. Good cold-flow properties for the purposes of the present invention refer to good dimensional stability against deformation and preferably also reduced settling on the part of the foam, preferably paired with a uniform density distribution for the same impression resistance.

### DETAILED DESCRIPTION OF THE INVENTION

The compounds of the present invention, a process for their preparation, the use of compounds for producing the polyurethane systems/foams and also the polyurethane systems/foams themselves are hereinbelow described by way of example without any intention to limit the invention to these exemplary embodiments. Where ranges, general formulae or classes of compounds are referred to in what follows, they shall encompass not just the corresponding ranges or groups of compounds that are explicitly mentioned, but also all sub-ranges and sub-groups of compounds which are obtainable by extraction of individual values (ranges) or compounds. Where documents are cited in the context of the present description, their content shall fully form part of the disclosure content of the present invention particularly in respect of the substantive matter in the context for which the document was cited. Percentages are by weight, unless otherwise stated. Average values referred to hereinbelow are weight averages, unless otherwise stated. Where properties of a material are referred to hereinbelow, for example viscosities or the like, the properties of the material at 25° C. are concerned, unless otherwise stated.

The compositions which the present invention provides for producing a polyurethane system, especially a polyurethane foam, comprise one or more compounds comprising at least one 5- or 6-membered ring comprising one or two oxygen atom(s) and carbon atoms.

There may be OH groups attached to the ring carbon atoms directly and/or via hydrocarbon chains, ring-shaped structures of the pyran type (pyranoses) and furan type (furanoses) being examples of compounds of this kind; or there are neither directly nor indirectly attached OH groups on the ring carbon atoms, as with glycol carbonate for example.

The composition of the present invention preferably comprises at least one compound comprising a 5- or 6-membered ring which is selected from the group of 5- or 6-membered polyols comprising at least 4 OH groups or their mono-, di- or triesters with a carboxylic acid, or glyceryl carbonate. Maltitol, sorbitan, sorbitan monooleate, sorbitan trioleate or sorbitan dihydride (1,2,3,6-dianhydro-D-sorbitol, isosorbide) are preferably present by way of 5- or 6-membered polyols comprising at least 4 OH groups or their mono-, di- or triesters.

The composition of the present invention may further comprise one or more solvents. The composition of the present invention preferably comprises water as a solvent.

The composition of the present invention may further comprise tin and/or zinc ricinoleate(s), tin carboxylate(s), polyalkylene glycol, e.g., polypropylene glycol or polyethylene glycol, preferably polyethylene glycol, and/or optionally one or more organic solvents. The tin and zinc salts used are preferably tin(II) and zinc(II) salts, respectively.

In addition to the compound(s) comprising a 5- or 6-membered ring, the composition of the present invention may also comprise a polyalkylene glycol, preferably polypropylene glycol or polyethylene glycol, more preferably polyethylene glycol. The mass ratio of the compound comprising a 5- or 6-membered ring to the polyalkylene glycols in the composition of the present invention is preferably in the range from 1:3 to 3:1, more preferably in the range from 1:2 to 2:1 and even more preferably in the range from 1:1.2 to 1.2:1. In some embodiments of the present invention, it may be advantageous for compositions according to the present invention which comprise polyalkylene glycol as well as compounds comprising a 5- or 6-membered ring to further comprise water. The water content is preferably in the range from 0.1 to 50 wt %, more preferably in the range from 1 to 25 wt %, based on the sum total formed from compounds comprising a 5- or 6-membered ring, polyalkylene glycol(s) and water.

The tin carboxylate(s) that can be used are preferably selected from monocarboxylic acids having 1 to 30, preferably 4 to 18 and more preferably 8 to 12 carbon atoms, especially tin salts of n-octanoic acid, n-nonanoic acid, 3,5,5-trimethylhexanoic acid, n-decanoic acid or 2-ethylhexanoic acid. Preferred tin carboxylates are those derived from carboxylic acids having more than just a single ethyl or n-propyl branch in position 2. The tin salts of 3,5,5-trimethylhexanoic acid or n-octanoic acid are particularly preferred tin carboxylates.

Any known polyethylene glycols can be used. The polyethylene glycols used are preferably waxy solids at 23° C. and atmospheric pressure. The composition of the present invention preferably comprises one or more polyethylene glycols, preferably having an average molecular weight Mw of 100 to 1500 g/mol, preferably of 150 to 1000 g/mol and more preferably of 200 to 500 g/mol.

In some embodiments of the present invention, it can be advantageous for the inventive composition to comprise a secondary amine, especially diethanolamine.

When the composition of the present invention is to be used for producing polyurethane systems, it can be advantageous for the composition to comprise one or more organic isocyanates having two or more isocyanate functions, one or more polyols having two or more isocyanate-reactive groups, optionally further catalysts for the isocyanate-polyol and/or isocyanate-water reactions and/or the trimerization of isocyanate, water, optionally physical blowing agents, optionally flame retardants and optionally further additives.

In some embodiments of the present invention, it can be advantageous for the production of polyurethane systems in particular for the composition to comprise one or more, preferably tertiary, amines, one or more silicone stabilizers and one or more emulsifiers as additional, i.e., extra additives.

Suitable isocyanates for the purposes of this invention are preferably any polyfunctional organic isocyanates, for example 4,4′-diphenylmethane diisocyanate (MDI), tolylene diisocyanate (TDI), hexamethylene diisocyanate (HMDI) and isophorone diisocyanate (IPDI). The mixture of MDI and more highly condensed analogues having an average functionality of 2 to 4 which is known as crude MDI is particularly suitable, as well as each of the various isomers of TDI in pure form or as isomeric mixture. Mixtures of TDI and MDI are particularly preferred isocyanates.

All organic substances having two or more isocyanate-reactive groups, and also preparations thereof, are preferably suitable polyols for the purposes of this invention. All polyether polyols and polyester polyols typically used for production of polyurethane systems, especially polyurethane foams, are preferred polyols. The polyols are preferably not compounds comprising one or more than one 5- or 6-membered ring constructed of one or two oxygen atoms and carbon atoms.

Polyether polyols are obtained by reaction of polyfunctional alcohols or amines with alkylene oxides. Polyester polyols are based on esters of polybasic carboxylic acids (which may be either aliphatic, as in the case of adipic acid for example, or aromatic, as in the case of phthalic acid or terephthalic acid, for example) with polyhydric alcohols (usually glycols). Natural oil based polyols (NOPs) can also be used. These polyols are obtained from natural oils such as, for example, soya or palm oil and can be used in the modified or unmodified state.

A suitable ratio of isocyanate to polyol, expressed as the index of the composition, is in the range from 10 to 1000, preferably from 40 to 350. This index describes the ratio of isocyanate actually used to the isocyanate calculated for a stoichiometric reaction with polyol. An index of 100 represents a molar ratio of 1:1 for the reactive groups.

The amount of tin and zinc salts optionally present in the composition of the present invention as catalysts is preferably in the range from 0.01 to 5 pphp (=parts by weight of tin and zinc ricinoleates and tin carboxylates based on 100 parts by weight of polyol), preferably in the range from 0.05 to 1 pphp.

Suitable additional catalysts for possible inclusion in the composition of the present invention are substances which catalyze the gelling reaction (isocyanate-polyol), the blowing reaction (isocyanate-water) or the di- or trimerization of the isocyanate. Typical examples are amines, e.g., triethylamine, dimethylcyclohexylamine, tetramethylethylenediamine, tetramethylhexanediamine, pentamethyldiethylenetriamine, pentamethyldipropylenetriamine, triethylenediamine, dimethylpiperazine, 1,2-dimethylimidazole, N-ethylmorpholine, tris(dimethylaminopropyl)hexahydro-1,3,5-triazine, dimethylaminoethanol, dimethylaminoethoxyethanol and bis(dimethylaminoethyl) ether, tin compounds such as dibutyltin dilaurate and potassium salts such as potassium acetate. It is preferable for further catalysts used to contain no organotin compounds, especially no dibutyltin dilaurate.

The amounts in which these additional catalysts are used depend on the type of catalyst and typically range from 0.01 to 5 pphp (=parts by weight based on 100 parts by weight of polyol) or from 0.1 to 10 pphp in the case of potassium salts.

The amount of water present in the additive compositions of the present invention depends on whether or not physical blowing agents are used in addition to water. In the case of purely water-blown foams, the water contents typically range from 1 to 20 pphp; when other blowing agents are used in addition to water, the amount of water used typically decreases to 0 or to the range from 0.1 to 5 pphp. To achieve high foam densities, neither water nor any other blowing agent is used.

Suitable physical blowing agents for the purposes of this invention are gases, for example liquefied CO₂, and volatile liquids, for example, hydrocarbons of 4 or 5 carbon atoms, preferably cyclo-, iso- and n-pentane, hydrofluorocarbons, preferably HFC 245fa, HFC 134a and HFC 365mfc, hydrochlorofluorocarbons, preferably HCFC 141b, oxygen-containing compounds such as methyl formate and dimethoxymethane, or hydrochlorocarbons, preferably dichloromethane and 1,2-dichloroethane. Suitable blowing agents further include ketones (e.g., acetone) or aldehydes (e.g., methylal).

In addition to or in lieu of water and any physical blowing agents, the additive composition of the present invention may also include other chemical blowing agents that react with isocyanates by evolving a gas, examples being formic acid and carbonates.

Suitable flame retardants for the purposes of this invention are liquid organophosphorus compounds, such as halogen-free organic phosphates, e.g., triethyl phosphate (TEP), halogenated phosphates, e.g., tris(1-chloro-2-propyl) phosphate (TCPP) and tris(2-chloroethyl) phosphate (TCEP), and organic phosphonates, e.g., dimethyl methanephosphonate (DMMP), dimethyl propanephosphonate (DMPP), or solids such as ammonium polyphosphate (APP) and red phosphorus. Suitable flame retardants further include halogenated compounds, for example, halogenated polyols, and also solids such as melamine and expandable graphite.

The composition of the present invention and the abovementioned compounds comprising at least one 5- or 6-membered ring comprising one or two oxygen atom(s) and carbon atoms can be used for producing a polyurethane system, preferably a polyurethane foam, for example. The term “polyurethane” is to be understood as a generic term for any polymer obtained from di- or polyisocyanates and polyols or other isocyanate-reactive species, such as, for example, amines, in that the urethane bond need not be the only or predominant type of bond. Polyisocyanurates and polyureas are also expressly included. The compositions of the present invention can in principle be used in any process for producing polyurethane systems. Processes for producing a polyurethane system which are in accordance with the present invention are accordingly distinguished by the use or employment of a composition which is in accordance with the present invention. The polyurethane systems obtained using the process of the present invention are preferably polyurethane coatings, polyurethane adhesives, polyurethane sealants, polyurethane elastomers or polyurethane foams.

Polyurethane systems which are in accordance with the present invention can be obtained by using a composition which is in accordance with the present invention. Preferred polyurethane systems in accordance with the present invention are especially polyurethane coatings, polyurethane adhesives, polyurethane sealants, polyurethane elastomers or polyurethane foams. The polyurethane system is preferably a rigid polyurethane foam, a flexible polyurethane foam, a viscoelastic foam, an HR polyurethane foam, a semi-rigid polyurethane foam, a thermoformable polyurethane foam or an integral foam, preferably an HR polyurethane foam.

The polyurethane systems of the present invention preferably comprise from 0.01 to 5 wt % of structural units based on compounds comprising at least one 5- or 6-membered ring constructed of one or two oxygen atoms and carbon atoms.

The processing of the compositions of the present invention into polyurethane systems, especially polyurethane foams, or, in other words, the production of polyurethane systems/polyurethane foams can be effected by any method known to a person skilled in the art, for example, by hand mixing or preferably using high-pressure or low-pressure foaming machines. The process of the present invention can be carried out as a continuous operation or as a batch operation. Batch operation is preferable for the process to produce moulded foams, refrigerators or panels. A continuous process is preferable to produce insulation sheets, metal composite elements, slabs or for spraying techniques.

In the process of the present invention, the constituents of the composition according to the present invention are preferably mixed together directly before, or alternatively, during the reaction (to form the urethane bonds). The constituents of the composition are preferably combined/added in a mix head.

In the process (use) of the present invention, the direct incorporation of a catalyst system comprising exclusively tin and/or zinc ricinoleate(s) and optionally tin carboxylate(s) is preferred. In the direct incorporation of the catalyst system, the mixture of tin and/or zinc ricinoleate(s) and optionally tin carboxylate(s) is preferably in liquid form in order that simplicity of addition may be ensured without the use of solvent.

Catalyst system viscosity as well as metal content can be varied by changing the chain length of the acid, so reactivity and viscosity can be optimized for the particular system. Direct metering of the viscous zinc/tin ricinoleate (salts of ricinoleic acid) into the polyurethane system components, especially foaming components, however, can lead to issues due to very high viscosity. Since many foamers only have direct metering, a product which can be individually adapted to the given circumstances is accordingly of huge advantage.

As an alternative to direct foaming, the catalyst system can also be incorporated in dilute form. Anhydrous solutions are preferable for this, since some tin/zinc salts have only limited stability to hydrolysis.

The polyurethane systems of the present invention, especially the polyurethane foams, can be used as refrigerator insulation, insulation panel, sandwich element, pipe insulation, spray foam, can foam, in particular 1 and 1.5 component can foam, wood imitation, modelling foam, packaging foam, mattress, furniture cushioning, automotive seat cushioning, headrest, dashboard, automotive interior trim, automotive roof liner, sound absorption material, steering wheel, shoe sole, carpet backing foam, filter foam, sealing foam, sealant and adhesive or for producing corresponding products.

Illustrative embodiments of the present invention will now be described by way of example without suggesting that the invention, the scope of which is apparent from the entire description and the claims, shall be construed as being restricted to the exemplary embodiments.

### EXAMPLES

Slabstock foams were produced on a Maxfoam F8 low-pressure foaming machine from Laader Berg. A detailed description of the production of slabstock foams can be extracted from DE-A-2142450.

The foaming machine was operated with the following parameters:
polyol output: 220 kg/min,
75 litres trough volume,
mixing chamber pressure 4.5 bar,
stirrer speed: 4500 rpm,
air loading: 3.0 l/min

The raw materials mentioned in Table 1 were used to produce the slabstock foams.

TABLE 1
Raw materials for producing the slabstock foams

| | |
|---|---|
| polyol 1 | polyetherol trifunctional, MW 4800, 25 wt % styrene- |
| | acrylonitrile filled, PCC Rokita |
| polyol 2 | polyetherol trifunctional, MW 6000, BASF |
| catalyst 1 | tertiary amine, 1,1′-{[3-(dimethyl- |
| | amino)propyl]imino}bispropane-2-ol, |
| | Evonik Industries AG |
| catalyst 2 | Tegoamin DEOA 85 (diethanolamine 85 wt % in water), |
| | Evonik Industries AG |
| catalyst 3 | zinc ricinoleate, Evonik Industries AG |
| catalyst 4 | tin ricinoleate, Evonik Industries AG |
| silicone | Tegostab B 8783 LF 2, Evonik Industries AG |
| stabilizer | |
| mixture 1 | polyethylene glycol* (20 wt %), water (25 wt %), |
| | d-glucitol (45 wt %), urea (10 wt %) |
| mixture 2 | polyethylene glycol* (50 wt %), maltitol syrup |
| | 75/75 (50 wt %) |
| isocyanate | tolylene diisocyanate, TDI 80, (80 wt % of 2,4-isomers, |
| | 20 wt % of 2,6-isomer, Bayer MaterialScience AG |

*PEG 200

The slabstock foams were produced using the formulations itemized in Table 2. The raw materials were pumped to the mix head via separate lines and stirred/mixed with each other in the mix head in the particular mixing ratio. Example V1 is a comparative test, Example EM1 is an example of the present invention.

TABLE 2
Formulation for producing the slabstock foams (particulars
in parts by mass per 100 parts by mass of polyol, with
CaCO₃ counting as a polyol)

| Example | V1 | EM1 |
|---|---|---|
| polyol 1 | 85 | 85 |
| polyol 2 | 9 | 9 |
| CaCO₃ | 6 | 6 |
| isocyanate index | 101 | 101 |
| isocyanate | 33.1 | 33.1 |
| water sep. | 1.9 | 2.1 |
| catalyst 1 | 0.1 | 0.1 |
| catalyst 2 | 0.6 | 0.6 |
| mixture 1 | 1.5 | — |
| mixture 2 | — | 1.5 |
| silicone stabilizer | 0.3 | 0.3 |
| catalyst 3 | 0.2 | 0.2 |
| catalyst 4 | 0.35 | 0.35 |

The slabstock foams obtained had an approximate size of about 1.13 m×2.05 m×2.05 m (H×W×D).

The slabstock foams thus obtained were measured in various places to determine their density and their hardness distribution (compressive strength, compressive stress). For this purpose, the surface of the slabstock foam was divided into 9 quadrants. Each foam specimen from the individual quadrants was subjected to a compressive test in accordance with German standard specification DIN 53577. The compressive stress determined at 40% compression corresponds to the compressive strength in kPa. The test specimens were measured with an H10KS universal tester from Tinius Olsen as follows:

First a slice 10 cm in thickness was cut from the foam obtained. Then, 10 cm of the bottom zone and 10 cm from each of the two sides were removed from the slice. Thereafter, the foam core remaining was cut into layers of 5 cm each. These slices were subsequently used to prepare the 10×10 cm test specimens.

The compressive strength was measured using a 10×10 cm plunger. The plunger compresses the test specimen three times before the actual measurement takes place at the fourth occasion. Loading and unloading curves were recorded for the foam. For examples of measured curves see: Becker, Braun, Kunststoff-Handbuch, Carl Hanser Verlag Munich, volume 7: Polyurethanes, p. 494, 1983. The compressive stress determined at 40% compression corresponds to the compressive strength in kPa.

The results of these determinations are reported in Table 3.

TABLE 3
Test results for density and compressive strength

| | V1 | EM1 |
|---|---|---|
| Density in kg/m³ | | |
| as measured in the slabstock foam at the . . . | | |
| top | 39 | 37.3 |
| Centre | 40.2 | 37.7 |
| bottom | 41.6 | 39.2 |
| Mean | 40.3 | 38.1 |
| Variation % | 2.6 | 1.9 |
| Compressive strength (compressive stress at 40% | | |
| compression)/deformation in kPa | | |
| as measured in the slabstock foam at the . . . | | |
| top | 3 | 3 |
| Centre | 3.1 | 3.1 |
| bottom | 3.1 | 3.1 |
| Mean | 3.1 | 3.1 |

As far as density distribution is concerned, Comparative Example V1 shows that the use of mixture 1 leads to a higher variation in density. The use of mixture 2 in Example EM1 shows a distinctly more homogeneous distribution of the density throughout the entire slabstock foam, as is the desired objective. The other mechanical properties such as compressive stress at 40% compression DIN EN ISO 3386, the tensile strength, breaking extension DIN EN ISO 1798 and the compression set (DIN EN ISO 1856) are not adversely affected, although this might have been possible because of the somewhat different composition of mixture 2.

While the present invention has been particularly shown and described with respect to preferred embodiments thereof, it will be understood by those skilled in the art that the foregoing and other changes in forms and details may be made without departing from the spirit and scope of the present invention. It is therefore intended that the present disclosure not be limited to the exact forms and details described and illustrated, but fall within the scope of the appended claims.

What is claimed is:

1. A composition for producing a polyurethane system comprising one or more compounds comprising at least one 5- or 6-membered ring comprising one or two oxygen atom(s) and carbon atoms.

2. The composition according to claim 1, further comprising tin and/or zinc ricinoleate(s), tin carboxylate(s), or polyethylene glycol, and optionally a solvent.

3. The composition according to claim 1, further comprising a secondary amine.

4. The composition according to claim 1, further comprising one or more organic isocyanates having two or more isocyanate functions, and one or more polyols having two or more isocyanate-reactive groups.

5. The composition according to claim 1, wherein said one or more compounds comprising a 5- or 6-membered ring are selected from the group consisting of 5- or 6-membered polyols comprising 4 OH groups or their mono-, di- or triesters with a carboxylic acid, or glyceryl carbonate.

6. The composition according to claim 5, wherein said 5- or 6-membered polyols comprising 4 OH groups or their mono-, di- or triesters comprise maltitol, sorbitan, sorbitan monooleate, sorbitan trioleate or isosorbide.

7. A polyurethane system comprising a composition comprising one or more compounds comprising at least one 5- or 6-membered ring comprising one or two oxygen atom(s) and carbon atoms.

8. The polyurethane system according to claim 7, wherein said composition further comprises one or more amines, one or more silicone stabilizers and one or more emulsifiers.

9. A process for producing a polyurethane system comprising:
providing a composition comprising one or more compounds comprising at least one 5- or 6-membered ring comprising one or two oxygen atom(s) and carbon atoms; and
adding said composition to a mixture comprising one or more organic isocyanates having two or more isocyanate functions and one or more polyols having two or more isocyanate-reactive groups.

10. The polyurethane system according to claim 8, wherein from 0.01 to 5 wt % of structural units based on compounds comprising at least one 5- or 6-membered ring constructed of one or two oxygen atoms and carbon atoms are present.

11. The polyurethane system according to claim 8, wherein said polyurethane system is a rigid polyurethane foam, a flexible polyurethane foam, a viscoelastic foam, an HR-foam, a semi-rigid polyurethane foam, a thermoformable polyurethane foam or an integral foam, preferably an HR polyurethane foam.

12. An article of manufacturing comprising a polyurethane system of claim 8.
